(19) United States
(12) Patent Application Publication
(10) Pub. No.: US 2025/0217453 A1
(43) Pub. Date: Jul. 3, 2025

(54) SYSTEMS AND METHODS FOR IDENTIFYING SCRIPTS BY CODING STYLES

(71) Applicant: CITRIX SYSTEMS, INC., Fort Lauderdale, FL (US)

(72) Inventors: WEI ZUO, NANJING (CN); KE WANG, NANJING (CN); KEVIN LI, NANJING (CN)

(21) Appl. No.: 18/856,766

(22) PCT Filed: Sep. 21, 2022
(86) PCT No.: PCT/CN2022/120187

§ 371 Date: Oct. 14, 2024

(51) Int. Cl. G06F 18/2415; G06F 8/30; G06F 8/33

(52) U.S. Cl. CPC G06F 18/2415; G06F 8/311; G06F 8/33

(57) ABSTRACT

Systems and methods for identifying scripts by coding style. A system can include one or more processors, coupled to memory. The system can identify a script for execution by a computing device of an entity. The system can determine, via a model trained with machine learning based on a plurality of scripts established by a plurality of entities, a classification of the script prior to execution of the script by the computing device. The system can control execution of the script responsive to the classification of the script.

### FIELD OF THE DISCLOSURE

This application generally relates to monitoring scripts, including but not limited to systems and methods for identifying scripts by coding styles.

### BACKGROUND

Information technology administrators and developers in companies may write scripts to make their routine tasks. The scripts can be launched as administrator privileges to perform almost everything on an endpoint. Meanwhile, cyber attackers may use some scripts to disable computers, steal data, or use a breached computer program to launch additional attacks since the script can be deployed easily.

### SUMMARY

Information technology (IT) administrators and developers of a company may suffer from balancing convenience and security. The IT administrators and developers may use command-line shell policies (e.g., AllSigned, or RemoteSigned) to block unknown scripts. On another side, security product vendors may design different components to detect different types of scripts. However, some IT developers may often write scripts for proof of concept (PoC) testing. The scripts can be changed frequently and may not be signed every time.

For a malicious command-line shell, attackers may obfuscate scripts to escape a signature detection. A machine learning based method can detect an obfuscated command-line shell at a landing stage of an attack. However, once the attackers take control of an endpoint, the attackers may perform attacks by scripts without obfuscation, such as a porting scanning, an installing autorun, or dumping credentials. The scripts may usually disguise as normal scripts to persist/keep/carry on an endpoint of a victim for a long time. There are more and more attack tools that can be rewritten by a commend-line shell (e.g., PowerShell, Nmap, or Mimikatz). The obfuscated command-line detection may not be sufficient to defend against endpoint attacks.

The systems and methods of this disclosure can address the technical problems by identifying a unique script coding style in each company and detecting an abnormal script before the abnormal script is launched. Employees of each company often follow a same coding style guide. This technical solution may be applied to any kinds of scripts.

An aspect of this disclosure can be directed to a system. The system can include one or more processors, coupled to memory. The one or more processors can identify a script for execution by a computing device of an entity. The one or more processors can determine, via a model trained with machine learning based on a plurality of scripts established by a plurality of entities, a classification of the script prior to execution of the script by the computing device. The one or more processors can control execution of the script responsive to the classification of the script.

The data processing system can be intermediary to the computing device and one or more servers. The one or more processors can be configured to intercept the script transmitted from the one or more servers to the computing device prior to receipt by the computing device of the script. The one or more processors can be configured to determine, via the model and prior to forwarding the script to the computing device, that the classification indicates the script is authorized for execution by the computing device. The one or more processors can be configured to forward the script to the computing device for execution responsive to the script being authorized for execution by the computing device.

The computing device may comprise the data processing system. The one or more processors can be configured to receive, via a network, the script from a remote device configured to remotely manage the computing device, the script compatible with a plurality of different platforms and configured with a command-line shell. The one or more processors can be configured to determine, responsive to receipt of the script from the remote device and prior to execution of the script on the computing device, the classification of the script. The one or more processors can be configured to control, responsive to the classification, execution of the script to prevent execution of the script or allow execution of the script on the computing device. In some embodiments, the one or more processors can be configured to prevent execution of the script by the computing device responsive to the classification comprising an indication that the script was developed by a second entity that is different from the entity. The computing device can be managed by the entity.

The one or more processors can be configured to determine, via the model, the classification of the script as one of developed internal to the entity or developed external to the entity. The one or more processors can be configured to scan the script to identify a plurality of values for a plurality of features of the script. The one or more processors can be configured to input the plurality of values for the plurality of features into the model to determine the classification.

The model can be trained with a plurality of features of the plurality of scripts developed by the plurality of entities. The plurality of features may comprise one or more features indicative of a coding style, a file attribute, or a code quality. The one or more processors can be configured to determine, for the entity, a plurality of features established in the model for the entity. The plurality of features may comprise at least one of a naming convention, bracket position, maximum line length, trailing whitespace, spare around keywords, style of cmdlet, or indentation. The one or more processors can be configured to scan the script to identify a plurality of values for the plurality of features established for the entity. A first value for a first feature of the plurality of features corresponding to the naming convention may indicate an amount of words in the script that use a camel-case or a snake-case. A second value for a second feature of the plurality of features corresponding to the bracket position may indicate that a bracket is located at an end of a line in the script or the bracket is located at a head of the line in the script.

The one or more processors can be configured to receive a second plurality of scripts from a third-party repository. The one or more processors can be configured to train an initial model based on a plurality of features of the second plurality of scripts. The plurality of features may comprise one or more features indicative of a coding style, a file attribute, or a code quality. The one or more processors can be configured to receive a third plurality of scripts developed by the entity. The one or more processors can be configured to classify, via the initial model, the third plurality of scripts of the entity into a category in the initial model trained based on the second plurality of scripts from the third-party repository. The one or more processors can be configured to train, based on the initial model and the category, the model as a binary classifier to output the classification as one of internal or external. The machine learning may comprise at least one of a support vector machine, a linear kernel function, or a radial basis kernel function.

An aspect of the present disclosure can be directed to a method for identifying abnormal scripts by coding style. The method can include identifying, by a data processing system comprising one or more processors coupled with memory, a script for execution by a computing device of an entity. The data processing system may determine a classification of the script prior to execution of the script by the computing device via a model trained with machine learning based on a plurality of scripts established by a plurality of entities. The data processing system may control execution of the script responsive to the classification of the script.

The data processing system can be intermediary to the computing device and one or more servers. The data processing system may intercept the script transmitted from the one or more servers to the computing device prior to receipt by the computing device of the script. The data processing system may determine, via the model and prior to forwarding the script to the computing device, that the classification indicates the script is authorized for execution by the computing device. The data processing system may forward the script to the computing device for execution responsive to the script being authorized for execution by the computing device.

The computing device may comprise the data processing system. The data processing system may receive, via a network, the script from a remote device configured to remotely manage the computing device. The script may be compatible with a plurality of different platforms and configured with a command-line shell. The data processing system may determine, responsive to receipt of the script from the remote device and prior to execution of the script on the computing device, the classification of the script. The data processing system may control, responsive to the classification, execution of the script to prevent execution of the script or allow execution of the script on the computing device.

The data processing system may prevent execution of the script by the computing device responsive to the classification comprising an indication that the script was developed by a second entity that is different from the entity. The computing device can be managed by the entity. The data processing system may determine, via the model, the classification of the script as one of developed internal to the entity or developed external to the entity. The data processing system may scan the script to identify a plurality of values for a plurality of features of the script. The data processing system may input the plurality of values for the plurality of features into the model to determine the classification. The data processing system may receive a second plurality of scripts from a third-party repository. The data processing system may train, via the machine learning, an initial model based on a plurality of features of the second plurality of scripts. The plurality of features may comprise one or more features indicative of a coding style, a file attribute, or a code quality. The machine learning may comprise at least one of a support vector machine, a linear kernel function, or a radial basis kernel function. The data processing system may receive a third plurality of scripts developed by the entity. The data processing system may classify, via the initial model, the third plurality of scripts of the entity into a category in the initial model trained based on the second plurality of scripts from the third-party repository. The data processing system may train, based on the initial model and the category, the model as a binary classifier to output the classification as one of internal or external.

An aspect the present disclosure can be directed to a non-transitory computer readable medium storing program instructions. The non-transitory computer-readable medium can store instructions that, when executed by one or more processors, cause the one or more processors to identify a script for execution by a computing device of an entity. The instructions can include instructions to determine, via a model trained with machine learning based on a plurality of scripts established by a plurality of entities, a classification of the script prior to execution of the script by the computing device. The instructions can include instructions to control execution of the script responsive to the classification of the script. The model may comprise a plurality of features comprising at least one of a naming convention, bracket position, maximum line length, trailing whitespace, spare around keywords, style of cmdlet, or indentation.

These and other aspects and implementations are discussed in detail below. The foregoing information and the following detailed description include illustrative examples of various aspects and implementations, and provide an overview or framework for understanding the nature and character of the claimed aspects and implementations. This Summary is not intended to identify key features or essential features, nor is it intended to limit the scope of the claims included herewith. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 is an example block diagram for identifying scripts by coding styles, in accordance with one or more implementations;

FIG. 3 is an example block diagram for identifying scripts by coding styles, in accordance with one or more implementations;

FIG. 4 is an example illustration of a coding style of a script, in accordance with one or more implementations;

FIG. 5 is an example flow diagram of a method for identifying scripts by coding styles, in accordance with one or more implementations;

FIG. 6 is an example illustration of a cluster graph, in accordance with one or more implementations;

FIG. 7 is an example flow diagram of a method for training a cluster model, in accordance with one or more implementations;

FIG. 8 is an example flow diagram of a method for training a cluster model, in accordance with one or more implementations;

FIG. 9 is an example flow diagram of a method for identifying scripts by coding styles, in accordance with one or more implementations;

FIG. 10 is an example flow diagram of a method for identifying abnormal scripts by coding styles, in accordance with one or more implementations;

FIG. 11 is an example block diagram for identifying scripts by coding styles, in accordance with one or more implementations; and

FIG. 12 is an example flow diagram of a method for identifying abnormal scripts by coding styles, in accordance with one or more implementations.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes systems and methods for identifying scripts by coding styles.

### A. Computing Environment

Prior to discussing the specifics of embodiments of the systems and methods of an appliance and/or client, it may be helpful to discuss the computing environments in which such embodiments may be deployed.

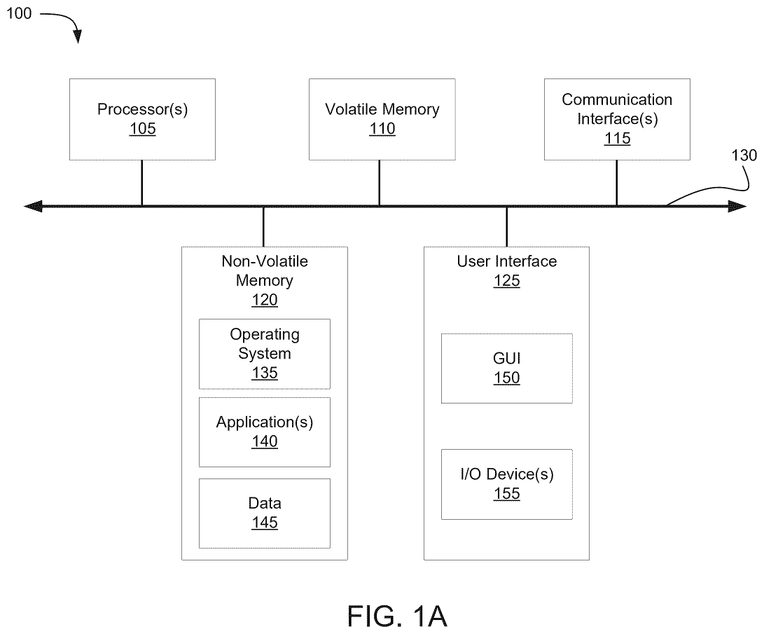

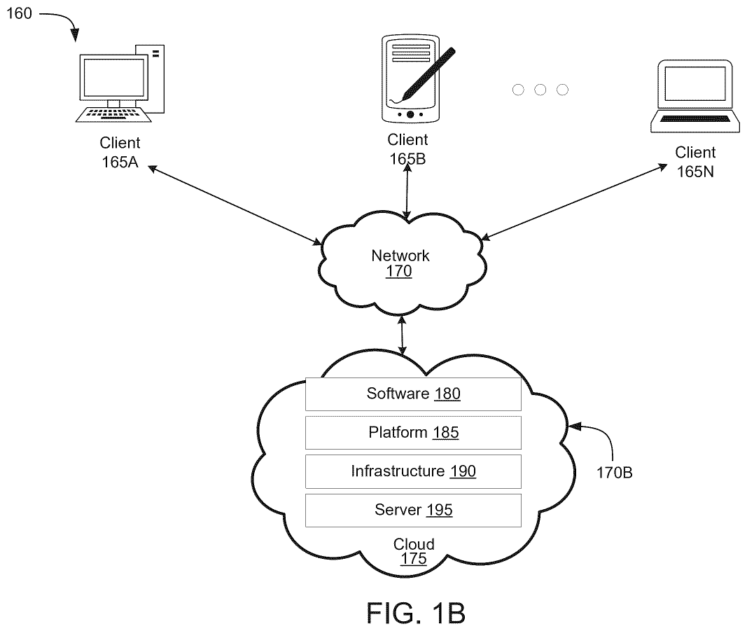

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 108 may include back-end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington; RACKSPACE CLOUD provided by Rackspace US, Inc., of San Antonio, Texas; Google Compute Engine provided by Google Inc. of Mountain View, California; or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington; Google App Engine provided by Google Inc.; and HEROKU provided by Heroku, Inc., of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, California; or OFFICE 365 provided by Microsoft Corporation. Examples of SaaS may also include data storage providers, e.g., DROPBOX provided by Dropbox, Inc., of San Francisco, California; Microsoft SKYDRIVE provided by Microsoft Corporation; Google Drive provided by Google Inc.; or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods for Identifying Scripts by Coding Styles

For a malicious command-line shell, attackers may obfuscate scripts to escape a signature detection. Some machine learning based methods may detect an obfuscated command-line shell at a landing stage of an attack. However, once the attackers take control of an endpoint, the attackers may perform attacks by scripts without obfuscation (e.g., a porting scanning, an installing autorun, or dumping credentials). The obfuscated command-line detection may not be sufficient to defend against endpoint attacks. Another choice is a behavior-based detection method. A detection engine may monitor behaviors of a command-line script in runtime and may take an action according to pre-defined policies. The main flaw of the behavior-based detection method can be that it is hard to estimate how much damage a script has already done when the script is detected.

The systems and methods of this technical solution can identify a unique script coding style in each company and detect an abnormal script before the abnormal script is launched. The technology leverages a machine learning method to identify a script coding style within a company and to block suspicious scripts with different coding styles before the scripts are launched in their computing environment. This technical solution may be applied to any kind of scripts.

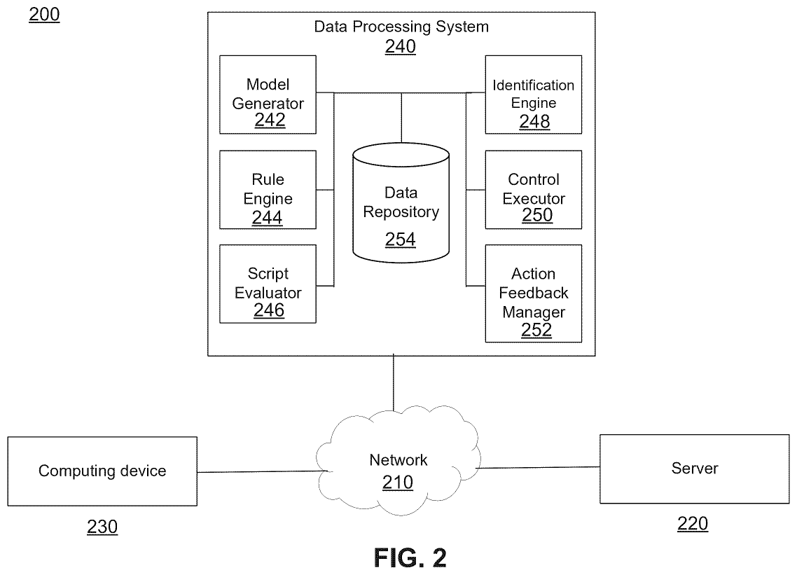

Referring to FIG. 2, depicted is a block diagram of an example system 200 for identifying scripts by coding styles. The system 200 can include an interface with or otherwise communication with at least one server 220, at least one computing device 230, or at least one data processing system 240 via a network 210. The data processing system 240 can be intermediary to the server 220 and the computing device 230. The system 200 or its components (e.g., network 210, server 220, computing device 230, or data processing system 240) can include or be composed of hardware, software, or a combination of hardware and software components. The one or more components (e.g., server 220, computing device 230, or data processing system 240) of the system 200 can establish communication channels or transfer data via the network 210. For example, the server 220 can communicate with at least one of the data processing system 240 or the computing device 230 via the network 210. In another example, the data processing system 240 can communicate with other devices, such as the server 220 or the computing device 230 via the network 210. The communication channel between various different network devices can communicate with each other via the network 210 or different networks 210.

The network 210 can include computer networks such as the Internet, local, wide, metro or other area networks, intranets, satellite networks, other computer networks such as voice or data mobile phone communication networks, and combinations thereof. The network 210 may be any form of computer network that can relay information between the one or more components of the system 200. The network 210 can relay information between server(s) 220 and one or more information sources, such as web servers or external databases, amongst others. In some implementations, the network 210 may include the Internet and/or other types of data networks, such as a local area network (LAN), a wide area network (WAN), a cellular network, a satellite network, or other types of data networks. The network 210 may also include any number of computing devices (e.g., computers, servers, routers, network switches, etc.) that are configured to receive and/or transmit data within the network 210. The network 210 may further include any number of hardwired and/or wireless connections. Any or all of the computing devices described herein (e.g., server 220, computing device 230, or data processing system 240) may communicate wirelessly (e.g., via WiFi, cellular, radio, etc.) with a transceiver that is hardwired (e.g., via a fiber optic cable, a CAT5 cable, etc.) to other computing devices in the network. Any or all of the computing devices described herein (e.g., server 220, computing device 230, or data processing system 240) may also communicate wirelessly with the computing devices of the network via a proxy device (e.g., a router, network switch, or gateway). In some implementations, the network 210 can be similar to or can include the network 170 or a computer network accessible to the computer 100 described herein above in conjunction with FIG. 1A or 1B.

The system 200 can include or interface with at least one server 220. The server 220 may be referred to as a host system, a cloud device, a remote device, a remote entity, or a physical machine. The server 220 can include or correspond to as a node, remote devices, remote entities, application servers, or backend server endpoints. The server 220 can be composed of hardware or software components, or a combination of both hardware or software components. The server 220 can include resources for executing one or more applications, such as SaaS applications, network applications, or other applications within a list of available resources maintained by the server 220. The server 220 can include one or more features or functionalities of at least resource management services (e.g., resource management services) or other components within the cloud computing environment (e.g., cloud computing environment). The server 220 can communicate with the computing device 230 via a communication channel established by the network 210, for example.

The system 200 can include or interface with at least one computing device 230. The computing device 230 can include at least one processor and a memory, e.g., a processing circuit. The computing device 230 can include various hardware or software components, or a combination of both hardware and software components. The computing device 230 can be constructed with hardware or software components and can include features and functionalities similar to the client devices 165 described hereinabove in conjunction with FIGS. 1A-B. For example, the computing device 230 can include, but is not limited to, a cluster node, a television device, a mobile device, smart phone, personal computer, a laptop, a gaming device, a kiosk, or any other type of computing device.

The system 200 can include at least one data processing system 240. The data processing system 240 can include various components to manage a script identification process. The data processing system 240 can include at least one model generator 242. The data processing system 240 can include at least one rule engine 244. The data processing system 240 can include at least one script evaluator 246. The data processing system 240 can include at least one identification engine 248. The data processing system 240 can include at least one control executor 250. The data processing system 240 can include at least one action feedback manager 252. The data processing system 240 can include at least one data repository 254. Individual components (e.g., model generator 242, rule engine 244, script evaluator 243, identification engine 248, control executor 250, action feedback manager 252, or data repository 254) of the data processing system 240 can be composed of hardware, software, or a combination of hardware and software components. Individual components of the data processing system 240 can be in electrical communication with each other. For instance, the model generator 242 can exchange data or communicate with the rule engine 244, script evaluator 243, identification engine 248, control executor 250, action feedback manager 252, or data repository 254. The one or more components of the data processing system 240 can be used to perform features or functionalities, such as identifying at least one script, determining at least one classification, or controlling execution. The data processing system 240 can operate remotely from the server 220, the computing device 230, or other devices in the system 200.

In some cases, the data processing system 240 can be a part of the server 220 or the computing device 230, such as an integrated device, embedded device, a server-operated device, or a device accessible by the administrator of the server 220. For example, the data processing system 240 can perform operations local or on-premise to the computing device 230 or the server 220. One or more components (e.g., model generator 242, rule engine 244, script evaluator 243, identification engine 248, control executor 250, action feedback manager 252, or data repository 254) of the data processing system 240 can be executed on the server 220 or the computing device 230. The data processing system 240 can be a part of or correspond to a virtual machine of the server 220 executing an application for the computing device 230. For example, the operations of the data processing system 240 can be performed by the virtual machine assigned to the respective computing device 230. In some cases, one or more components or functions of the data processing system 240 can be packaged into a script, agent, or bot configured to execute on the server 220 or computing device 230.

In some embodiments, the model generator 242 may train an initial model based on one or more scripts. The initial model can be a machine learning baseline model (e.g., eXtreme Gradient Boosting (XGBoot) model). The XGBoot may transform multiple decision trees (hundreds or thousands of decision trees) into a single born-again decision tree that approximates same decision function. The one or more scripts may be developed by one or more entities (e.g., internal entities of a company, external entities of the company, or third-party entities). In certain embodiments, the one or more scripts can be from public source code repositories. The one or more scripts may include one or more features. The one or more features may comprise an indicator of a coding/writing style, a file attribute, or a code quality. The code quality may be defined by a defect metric or a complexity metric. The defect metric can be a number of defects (or severity of the defects) in the script. The complexity metric may include a number of linearly independent paths with the script or a testing time of the script. The model generator 242 may train an initial model (e.g., machine learning baseline model) to “learn” a coding style by leveraging machine learning. The model generator 242 may extract the one or more features (e.g., writing styles, functions, file attributes, or code qualities) from a script to train the machine learning model with a coding style. There can be several definitions/features to train the machine learning model.

The model generator 242 may receive one or more scripts from a third-party repository. The model generator 242 may train an initial model based one or more features of the one or more scripts. The one or more features may indicate a coding style, a file attribute, or a code quality. The model generator 242 may receive one or more scripts developed by an entity. The initial model may classify one or more scripts of the entity into a category in the initial model trained based on the one or more scripts from the third-party repository. For example, the initial model may include category A, B, C, and D. The model generator 242 may classify a first script developed by the entity into category C, and may classify a second script from the third-party repository into category A, B, or D, according to the training processes. The model generator 242 may train the model as a binary classifier to output the classification as one of internal or external based on the initial model and the category. The binary classifier may categorize new observations into one of two class labels (e.g., spam or not) via a supervised learning algorithm. After the initial model is trained, the model generator 242 may generate a model.

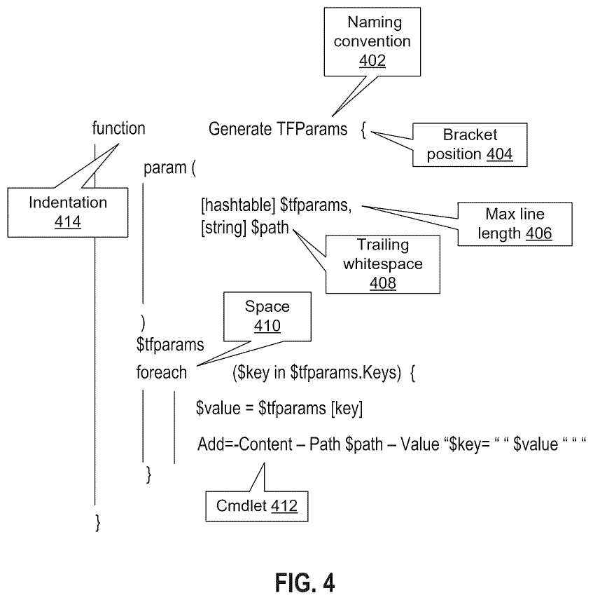

Different administrators may write command-line shell codes in different styles. FIG. 4 is an example illustration of a writing style of a script. The coding style may include a naming convention 402, a bracket position 404, a maximum line length (or total lines in one script) 406, a trailing whitespace 408, a space around a keyword 410, a style of a command-let (cmdlet) 412, or an indentation 414. The naming convention can a number (or a percentage) of words in the script that use a camel-case (e.g., FileNotFound), a snake-case (e.g., build_docker_image), a pascal-case (e.g., TechTerms), or a kebab-case (e.g., THIS-IS-A-KEBAB). Camel case can refer to a typographical convention in which an initial capital is used for the first letter of a word forming the second element of a closed compound. Snake case can refer to a style of writing in which each space is replaced by an underscore. Pascal case can refer to a programming naming convention where the first letter of each compound word in a variable is capitalized. Kebab case can refer to a programming variable naming convention where spaces between words are replaced with a dash. The bracket position (e.g., a left bracket position) can be located at an end of a line in the script or can be located at a head of a new line in the script. The maximum line length (or total lines) of the script can a number of words. A statement with a large number of words may be divided into multiple short parts for a readable coding. For the trailing whitespace, different operating systems (e.g., Windows or Linux) may use different trailing whitespaces (e.g., a carriage return plus a line feed (CRLF) or a line feed (LF)). The space around keywords, brackets, or operators can a number of space placed around the keywords. For the style of the cmdlet, some administrators may prefer to use an alias of the cmdlet, such as using “iex” instead of an Invoken-Expression. The indentation can be how many spaces/tabs used a beginning of each line in the script. In certain embodiments, other administrators may prefer to use a base64 encode, which can also be treated as a coding style. An obfuscated command-line shell can also be treated as a coding style.

“Naming Conventions”, “Bracket Positions”, “Max Line Length”, “Trailing Whitespace”, “Space around Keywords”, “Style of Cmdlet”, or “Indentation” can be extracted to identify a coding style of a script, as shown in Table 1.

TABLE 1

| | | | | Space | Style | |
|---|---|---|---|---|---|---|
| Naming | Bracket | Max Line | Trailing | around | of | |
| Conventions | Positions | Length | Whitespace | Keywords | Cmdlet | Indentation |
| 0: unknown | 1: at | Min/Main/Avg | 0: CRLF | 0: <50% | 1: | Average of |
| 1: >50% | the end | characters of | 1: LF | uses space | >50% | space |
| uses camel- | of | line | | around | uses | characters |
| case | line | | | keywords | the | at the head |
| 2: >50% | 2: at the | | | 1: >=50% | Full | of each |
| uses snake- | head of | | | does | Name | line |
| case | line | | | not use | 2: | |
| | | | | space | >50% | |
| | | | | around | uses | |
| | | | | keywords | the | |
| | | | | | Short | |
| | | | | | Name | |

A computing device can execute a script to manage a system resource by updating grand piece online (GPO) codes, modifying Registry, or changing Files. For example, some operations, cmdlets, or native application programming interfaces (APIs) can be used frequently in some companies according to business and working scenarios. In the contrary, some functions may be not used in the companies oftentimes. In such case, “Percentage of Registry operation”, “Percentage of File operation”, “Percentage of Process operation”, “Percentage of Network operation”, or “Number of DllImport” can be extracted to identify a coding style of a script, as shown in Table 2.

TABLE 2

| Percentage | Percentage | Percentage | Percentage of | |
|---|---|---|---|---|
| of Registry | of File | of Process | Network | Number of |
| operation | operation | operation | operation | DllImport |
| 5% | 1% | 10% | 5% | 2 |

Some administrators may save their scripts in specific folders or repositories. A size of each script may also reflect a coding style so that the model generator can extract more features from file attributes. In such case, “Path”, “Size”, “Attribute”, “Zone.Identifier”, “Editor”, or “Timestamp” can be extracted to identify a coding style of a script, as shown in Table 3. “Editor” may mean/indicate a last process name that edits or creates the file. If the administrator edits the file, the Editor can be “notepad” or “vscode.” If the file is downloaded, the Editor can be “chrome” or “outlook.”

TABLE 3

| Path | Size | Attribute | Zone.Identifier | Editor | Timestamp |
|---|---|---|---|---|---|
| 0: Path in | 1: <1k | 0: normal | ZoneId (NTFS | 0: Other | LastModifyTime- |
| “Desktop” | 2: <5k | 1: hidden | only) | 1: VSCode | LastCreatedTime |
| 1: Path in | 3: <10k | 2: system | | 2: Notepad | |
| % AppData % | 4: >0k | | | 3: Chrome | |
| 2: Path in | | | | . . . | |
| % System″ | | | | | |
| 3: Path in | | | | | |
| % temp % | | | | | |
| . . . | | | | | |

Lint or other static scan tools may obtain an evaluation of a code quality, which can be also used to identify a coding style of a script, as shown in Table 4.

TABLE 4

| General Complexity | Gramma Complexity |
|---|---|
| Shannon Entropy | Abstract Syntax Tree (depth(D), width(W), |
| | nodes(N) . . . ), it can be simply defined as |
| | $A = \frac{1}{1 + {e}^{- ( + {μ}_{1 D} + {μ}_{2 W} + {μ}_{3 N} + {μ}_{4 …} )}}$ |
| | Those μᵢ(s) are used to adjust the weights |
| | across different attributes. |

The above features and encoding formulas are purely for making an example. The model generator may involve more features and much more complex encoding formulas for a model training.

The model generator 242 may determine or create one or more clusters from the scripts. A cluster can be a group of data objects with one or more similar features. For example, the model generator 242 may scan one or more scripts and may extract the above coding style features (e.g., bracket positions and naming conventions) from the one or more scripts from open-source repositories. An unsupervised learning approach can be applied to the data set to train a cluster model M. K-means clustering algorithm may be used. The source codes of the data set may be clustered into K categories (e.g., 3 categories). Each group or cluster may have a threshod value for each feature. In some embodiments, Elbow method or Silhouette method can be used to determine an optimal number of K. The scripts with one or more similar features (e.g., similar bracket positions and similar naming conventions) may be grouped in a same group. For example, script A has 95% brackets located at the end of a line and 97% naming in snake-case, script B has 90% brackets located at the head of a line and 98% naming in camel-case, and script C has 80% brackets located at the end of a line and 90% naming in snake-case. The script A and the script C can be clustered together since the cluster has a threshold of 70% brackets located at the end of a line and 80% naming in snake-case.

The model generator 242 may utilize the one or more clusters (e.g., A, B, and C clusters) to classify the one or more scripts. Most of scripts from a certain company may be classified into one or more clusters (e.g., C cluster) of the one or more clusters. The model generator 242 may match or mark a script from the certain company to one or more clusters (e.g., C cluster). The model generator 242 may generate a category for the script from the certain company. The category may include one cluster or a combination of different clusters. The category can be “internal” or “external.” “Internal” may mean or indicate a coding style of scripts in this category can be widely used in a certain company. “External” may mean or indicate a coding style of scripts can be unfamiliar to the certain company.

The model generator 242 may extract the one or more features from the one or more scripts to build feature vectors with multiple dimensions. The model generator 242 may build a supervised machine learning model according to the multiple dimensions feature vectors. For example, the model generator may train a binary classification supervised learning model using a support vector machine (SVM) algorithm. The machine learning may comprise at least one of a support vector machine, a linear kernel function, or a radial basis kernel function. The support vector machine can be a supervised machine learning model that uses classification algorithms for two-group classification problems. The linear kernel function and the radial basis kernel may take data as input and transform the data into a required form. Specifically, the radial basis kernel function may have localized and finite response to an entire x-axis.

Referring back to FIG. 2 now, the rule engine 244 may receive a configuration/model from the model generator 242. The configuration may include one or more rules of different companies. For example, there can be A, B, C, and D clusters. A script from a certain company may be classified into B or C cluster. In some embodiments, the rule engine 244 may adjust the configuration in response to an action feedback. For instance, an action feedback may indicate that the certain company change coding style to include A cluster. The rule engine may adjust the configuration to include A cluster according to the action feedback.

The rule engine 244 may trigger the model generator 242 to train a new configuration/model according to a define event or a defined time information. The defined event may comprise a detection error rate (e.g., a false positive rate) of malicious scripts being above a threshold. The defined time information may include a periodic time interval. As another example, the rule engine may adjust the configuration periodically (e.g., every month).

The rule engine 244 may store a rule (e.g., access permission) of a category/classification (e.g., internal or external) of a script. For example, a script with a classification of “internal” may be authorized for execution by a computing device, and a script with a classification of “external” may be blocked or prevented from execution by a computing device. In some embodiments, the rule engine may adjust the rule in response to an action feedback. For example, an action feedback may indicate that a certain category may be allowed to execute on the computing device. The rule engine may adjust the rule to allow the certain category to execute on the computing device according to the action feedback.

In some embodiments, the script evaluator 246 may determine a classification (e.g., a binary classification) of a script via a model trained with machine learning. The model may be trained with machine learning based on one or more scripts established by one or more entities. The binary classification may include an “internal” or an “external.” The internal may indicate that the scripts is developed internal to an entity. The external may indicate that the scripts is developed external to the entity. When there is a new or unknown script, the script evaluator 246 may scan the new script and may determine a classification (e.g., internal or external) of the new script prior to execution of the new script by the computing device. For example, the script evaluator may classify a new script as “internal” based on a trained support vector machine (SVM) algorithm. The script evaluator 246 can be used to detect an abnormal script before the abnormal script is launched by the computing device. Since a company often follows same coding style guide, the script evaluator 246 may detect any scripts using an unfamiliar coding style.

The script evaluator 246 may determine a rating/score of a script via a model trained with machine learning (e.g., a trained machine learning baseline model). The script evaluator 246 may determine a classification of the script based on the rating/score of the script. For example, the script evaluator 246 may rate a script with “good” lower than 50%. The script evaluator 246 may classify the script as “external” based on the rating of “good” lower than 50%.

The script evaluator 246 may evaluate one or more values for one or more features by the trained model to determine a classification. For instance, the script evaluator 246 may obtain a first value (e.g., 70%) of greater than 50% using snake-case and a second value (e.g., 34%) of less than 40% using a full name for a script. The script evaluator 246 may compare the first value and the second value of the script with different thresholds from different clusters trained by the model. The script evaluator may decide that the first and the second value of the script is closest to cluster D (e.g., an internal cluster). The script evaluator may determine that the classification of the script is “internal.”

The identification engine 248 may receive a script for execution by a computing device of an entity. In some cases, the identification engine 248 may intercept a script transmitted from the server to the computing device prior to receipt by the computing device of the script. For example, the identification engine may receive one or more scripts from a third-party repository. As another example, the identification engine may receive one or more scripts developed by a certain entity. The identification engine may receive the script from a remote device configured to remotely manage the computing device. The script can be compatible with one or more different platforms and configured with a command-line shell.

The identification engine 248 may identify the script for execution. The identification engine 248 can identify a script responsive to receiving the script from a remote source, or responsive to receiving an instruction to execute the script. The script can be configured to perform a function or execute a process on the computing device 230. In some other cases, a script can be used for creating a hooking process for a software component. The identification engine 248 may decide a purpose of a script and forward the script to a destination for execution of the purpose. The identification engine 248 may identify the script based on a source (e.g., a path, or a URL address) of the script. The identification engine 248 can identify a unique identifier for the script, filepath for the script, developer of the script, or source of the script. After the identification, the identification engine 248 may forward the script to a corresponding engine in the data processing system. For example, if the identification engine identifies a new script for execution, the identification engine may forward the new script to the script evaluator. For another example, if the identification engine identifies a script (or one or more scripts) for a model training, the identification engine may forward the script (or the one or more scripts) to the model generator.

In some embodiments, the control executor 250 may control execution of the script responsive to the classification of the script. For instance, if a script is classified as “external,” the control executor may prevent execution of the script on the computing device. The control executor 250 may send an alert notification or an analytic result to a user interface (e.g., a user and entity behavior analytics (UEBA) dashboard) of an application. An administrator may make a final decision after reviewing the script. The control executor 250 may terminate the script from execution using a command line. When a script is authorized for execution by the computing device, the control executor may forward the script to the computing device for execution.

The action feedback manager 252 may receive feedback from an entity to improve an accuracy of the trained model. After the control executor 250 sent the analytic result to the user interface of the application, the administrator may provide feedback using the user interface. For example, the action feedback manager 252 may receive feedback, from an administrator, indicating that an “external” script is wrongly classified (e.g., a false alarm), and may update the script with an “internal” tag. The script may be put back into the “internal” data set for continually retraining. The action feedback manager 252 may update the trained machine learning model according to the feedback. As another example, the action feedback manager 252 may receive feedback, from the administrator, indicating that an “internal” script is correctly classified. The action feedback manager 252 may notify the rule engine 244 the feedback regularly to improve an accuracy of the trained model.

In some embodiments, the data repository 254 may be referred to as a data repository, central storage, or memory of the data processing system 240. The one or more storages (e.g., script storage, model storage, feedback storage, rule storage, or execution storage) can be accessed, modified, or interacted with by one or more components (e.g., model generator 242, rule engine 244, script evaluator 246, identification engine 248, control executor 250, or action feedback manager 252) of the data processing system 240. In some cases, the one or more storages of the data repository 254 can be accessed by one or more other authorized devices of the system 200, such as the server 220. The data repository 254 can include other storages to store additional data from one or more components of the data processing system 240 or data from other devices of the system 200, for example.

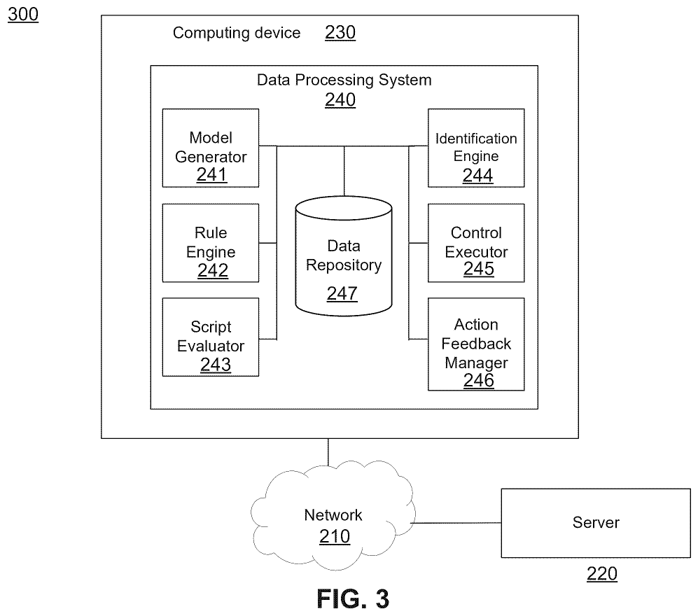

FIG. 3 illustrates a block diagram for identifying scripts by coding styles, in accordance with some embodiments. FIG. 3 basically includes the same elements as FIG. 2. The system 300 can include at least one network 210, at least one server 220, at least one computing device 230, and at least one data processing system 240. The computing device 230 may comprise the data processing system 240. The components (e.g., network 210, server 220, computing device 230, or data processing system 240) of the system 300 can include or be composed of hardware, software, or a combination of hardware and software components. The one or more components (e.g., server 220 or computing device 230) of the system 300 can establish communication channels or transfer data via the network 210. For example, the server 220 can communicate with the computing device 230 via the network 210. The communication channel between various different network devices can communicate with each other via the network 210 or different networks 210.

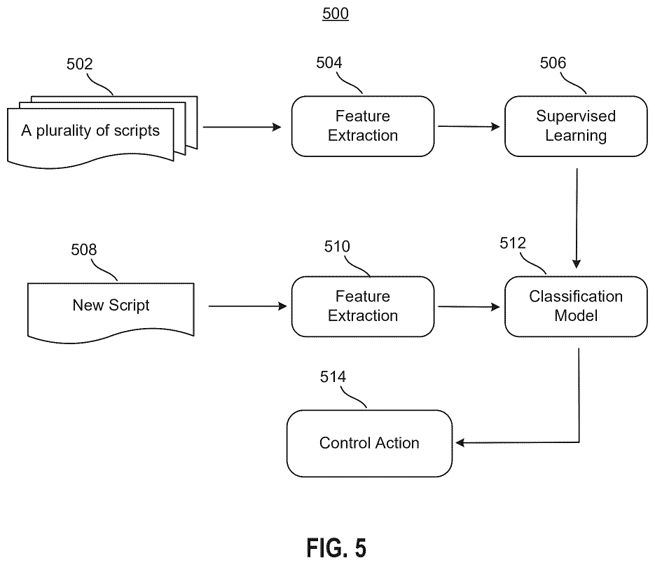

FIG. 5 is an example flow diagram of a method for identifying scripts by coding styles, in accordance with one or more implementations. The method 500 can be performed by one or more system or component depicted in FIGS. 1-3, including, for example, a data processing system. In brief overview, the method 500 can include the data processing system identifying or obtaining a plurality of scripts at ACT 502. At ACT 504, the method 500 can include the data processing system performing feature extraction. At ACT 506, the method 500 can include the data processing system performing supervised learning to generate or update a classification model. At ACT 508, the method 500 can include the data processing system receiving or identifying a new script. At ACT 510, the method 500 can include the data processing system performing feature extraction on the newly identified script. At ACT 512, the method 500 can include the data processing system inputting the extracted features into the classification model generated or updated at ACT 506. At ACT 514, the method 500 can include the data processing system controlling an action.

At ACT 502, the method 500 can include the data processing system identifying or obtaining a plurality of scripts. The data processing system may prepare or establish a training set and a testing set for a supervised machine learning. The data processing system may receive the scripts from a third-party repository or an enterprise repositories. In a non-limiting example, the script may be from a certain entity that intends to use the method 500. The scripts may be received from a remote device. The scripts may be compatible with one or more platforms. The data processing system may use the plurality of scripts as training samples for a machine learning model training.

At ACT 504, the method 500 can include the data processing system performing feature extraction. The data processing system may extract features from the training samples to build eight or higher dimensions feature vectors for example. The higher dimensions feature vectors may include information of writing styles, functions, file attributes, or code qualities. The feature extraction may reduce a number of features in a dataset by creating new features from the existing ones. The reduced set of features (e.g., the higher dimensions feature vectors) may summarize most of the information in the original set of features. The reduced set of features can be created from a combination of the original set of features.

At ACT 506, the method 500 can include the data processing system performing supervised learning to generate or update a classification model. The data processing system may build a supervised machine learning model by analyzing the training samples. The supervised machine learning model may produce an inferred function, which can be used for mapping new samples (e.g., scripts). For example, the data processing system can use eXtreme Gradient Boosting (XGBoot) for this task. The XGBoot may transform multiple decision trees (hundreds or thousands of decision trees) into a single born-again decision tree that approximates the same decision function. The result can be a well-trained machine learning model.

At ACT 508, the method 500 can include the data processing system receiving or identifying a new script. By hooking process creation, the data processing system can block a new script process before launching in order to evaluate the new script to determine whether to allow or authorize execution of the scripts. The data processing system can parse a command line of the new script to get a path of the script or cmdlets. The data processing system may put a result of the path and cmdlets of the new script into the trained model.

At ACT 510, the method 500 can include the data processing system performing feature extraction on the newly identified script. The data processing system may extract features from the newly identified script to build higher dimensions feature vectors. The higher dimensions feature vectors may include information of the newly identified script (e.g., writing styles, functions, file attributes, or code qualities). The data processing system may forward the result of feature extraction of the newly identified script to a trained classification mode.

At ACT 512, the method 500 can include the data processing system inputting the extracted features into the classification model generated or updated at ACT 506. The data processing system may use the trained model to get a rating of the newly identified script. The classification model may determine a classification of the newly identified script based on the rating of the newly identified script. For example, the classification model may classify the newly identified script as “external” based on the rating of “good” lower than 50%

At ACT 514, the method 500 can include the data processing system controlling an action. Controlling an action can refer to or include the data processing system sending an alert notification to a user interface of an application. For example, when a rating of “good” is lower than 50% (or less), the data processing system can notify other security components for taking an action. An administrator may provide feedback to the notification. The data processing system may improve an accuracy of the classification model based on the feedback.

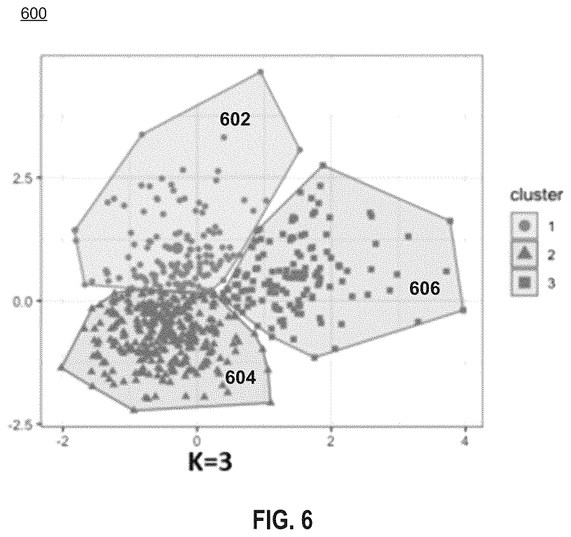

FIG. 6 is an example illustration of a cluster graph 600, in accordance with one or more implementations. A data processing system can categorize writing styles. For example, the data processing system can categorize existing writing styles from an open source repository prior to or instead of categorizing writing styles of a particular entity. The data set may come from an open-source repository accessible via a network. The data processing system may extract coding style features from the source codes of the data set. An unsupervised learning approach can be applied to the data set to train a cluster model M, such as a k-means clustering technique. The source codes can be clustered into K categories. Elbow method or Silhouette method can be options used to determine an optimal K, for example. When K=3, the result of k-means is shown in FIG. 6. The cluster graph 600 may include cluster 1 (602), cluster 2 (604), and cluster 3 (606). The data processing system may input scripts used in a company or entity into trained model M. Some or most of the scripts can be classified into one of the categories. The data processing system can mark that category as “internal”, and the others can be marked as “external”. There are two data sets: “internal” and “external”. “Internal” may mean the style of scripts in this category is widely used in the company. “External” may mean the style of script is unfamiliar to the company. As an illustrative example, cluster 1 (602) can be an internal category, and cluster 2 (604) and cluster 3 (606) can be external categories.

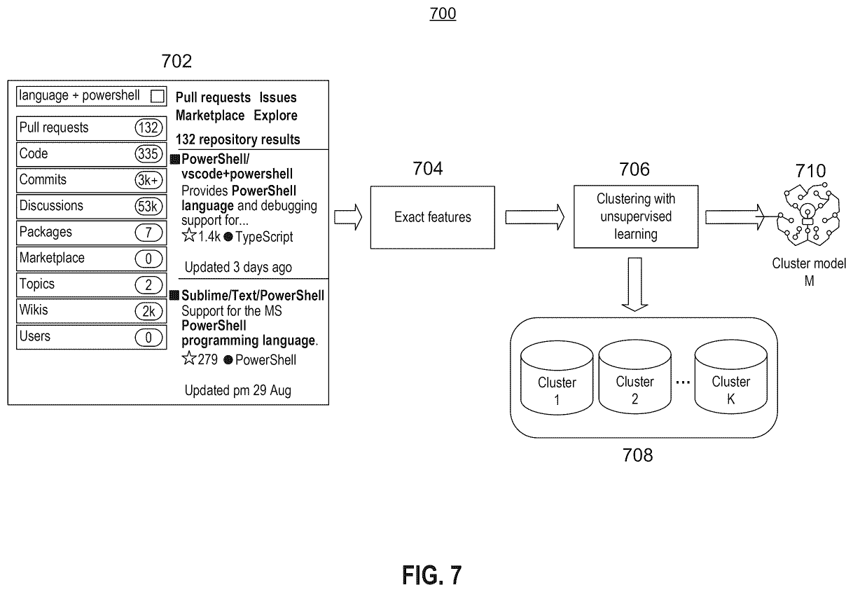

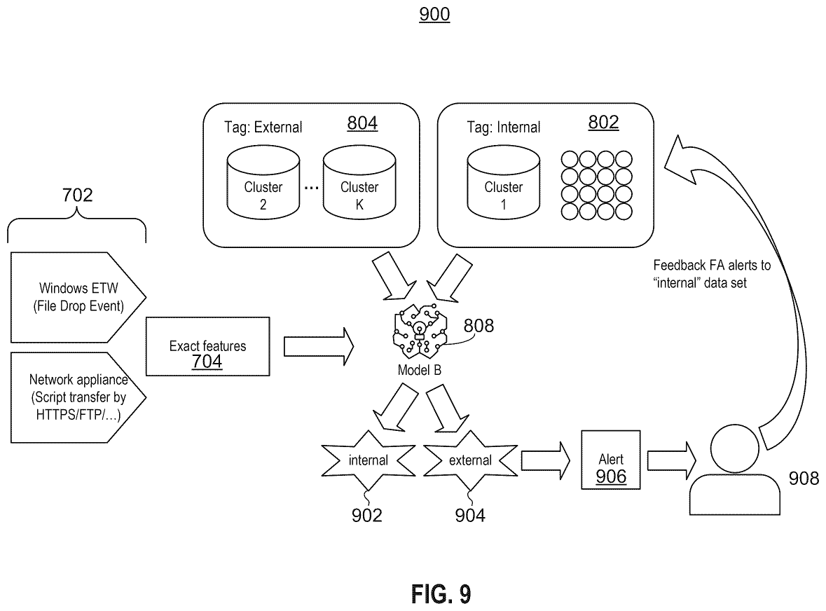

FIGS. 7-9 illustrate an example working flow for identifying scripts by coding styles. The methods 700, 800 and 900 can be performed by one or more system or component depicted in FIG. 1A, 1B or 2. At ACT 702, the method 700 can include the data processing system receiving code or scripts from public or open source code repositories. At ACT 704, the data processing system can extract features from the public source codes. At ACT 706, the data processing system can apply a unsupervised learning and generate K clusters 708 according to the extracted features. At ACT 710, the data processing system can update, train or cause a cluster model to learn from the training processes.

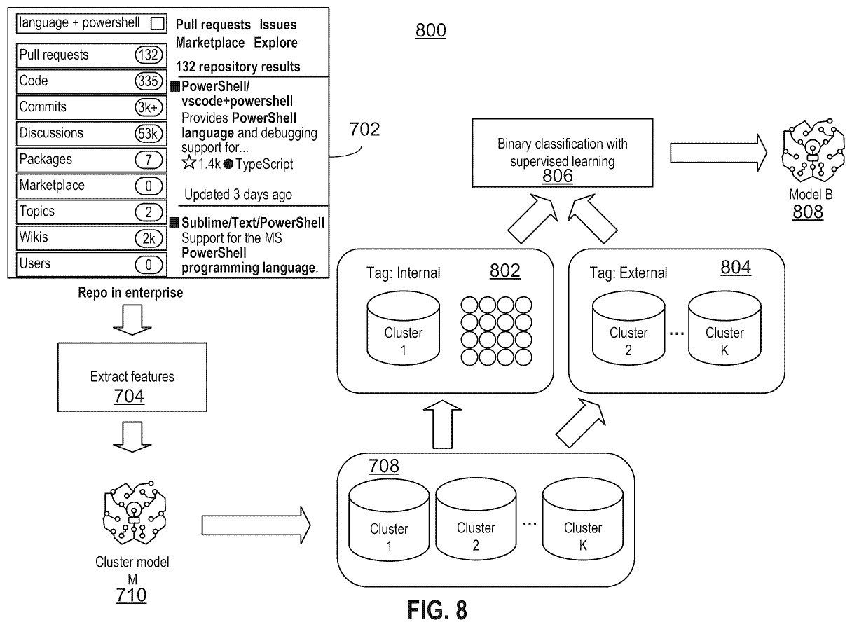

Referring to FIG. 8, the method 800 can include the data processing system obtaining code from a public repository at ACT 702. In method 800, the data processing system may use the cluster model M 710 to classify scripts of a company. At ACT 802, the data processing system can tag cluster 1 of the K clusters 708 as “internal.” The internal cluster can be a cluster that most the company's scripts belong to. At ACT 804, the data processing system can tag other cluster (e.g., clusters 2 to cluster k) as “external.” At ACT 806, the data processing system can apply a supervised learning with two tags and generate a binary classification. At ACT 808, the data processing system can train a binary classification model B from the supervised learning processes. The supervised learning may comprise a support vector network (SVM).

In method 900, the data processing system may input real-time data into the binary classification model B 808. The real-time data input can come from either Windows Event Log or online captures from network appliances 702. The data processing system may extract features 704 and may send the features to trained model B 808 when a new file is dropped or captured. At ACT 902, the data processing system may get a classified result “internal.” At ACT 904, the data processing system may get a classified result “external.” The output “external” 904 may indicate that the style of this script is not standard style in the company. At ACT 906, the data processing system may send an alert notification 906 based on the output via an interface of an application. At ACT 908, after receiving feedback from an administrator corresponding to the alert notification, the data processing system can forward the feedback to the binary classification model B. For example, the administrator 908 may mark the output as a false alarm if the output is not correct. The sample may be put back into the “internal” 802 or “external” 804 data set for continually retraining.

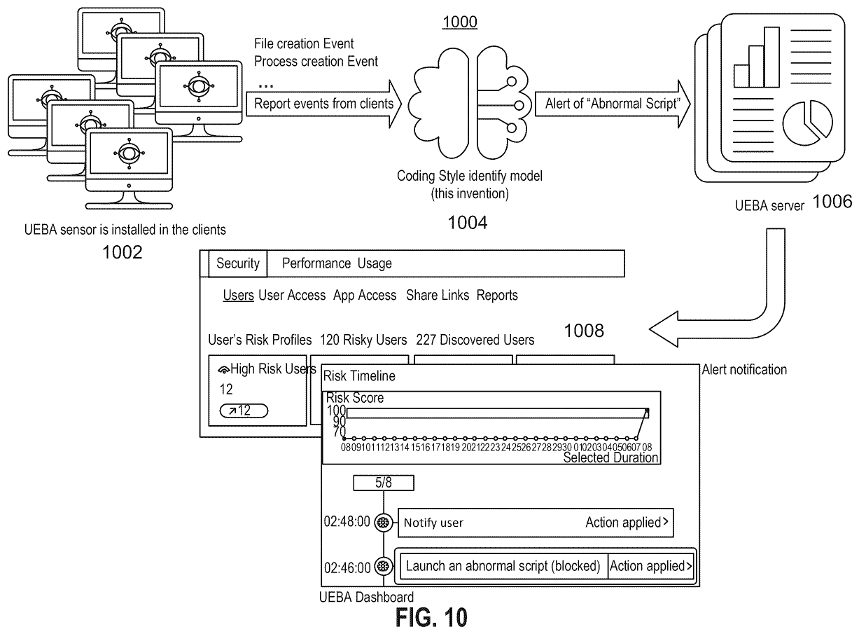

FIG. 10 is an example flow diagram of a method for identifying abnormal scripts by coding styles, in accordance with one or more implementations. This disclosure can be integrated into a sensor of user and entity behavior analytics (UEBA) solution 1002 in an analytics for security. The sensor 1002 may collect user behaviors, including process creation, or file creation. The script can be collected and analyzed before the script is launched. The result of the “Coding Style Identify Model” 1004 can be used as an input for a UEBA service 1006 in a backend. The UEBA service 1006 can make a final decision 1008 by correlating many behaviors. An administrator can approve the script manually. The style of this script can be feedback to the training set with the “internal” tag. The samples can be retrained regularly to improve an accuracy of this model.

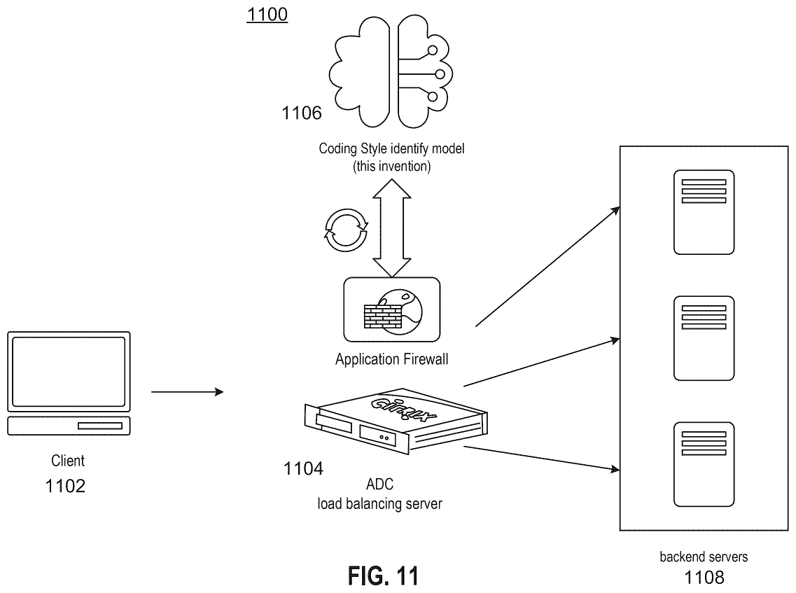

FIG. 11 is an example block diagram for identifying scripts by coding styles, in accordance with one or more implementations. This disclosure can be integrated into an application delivery controller (ADC) solution 1104. More specifically, this disclosure can be integrated into an application firewall to prevent security breaches, or possible unauthorized modifications to websites that access sensitive business or customer information. Application firewall features can be tapped to periodically synchronize with coding style identify model 1106 to retrieve a latest standard of security model 1106. The security mode 1106 can be applied to the application firewall policy on an application delivery controller (ADC) 1104. Administrators 1102 can apply the required policies manually based on requirements by choosing desired one, which can provide some granularity. In some cases, the administrators may simply follow the results provided by coding style identify model 1106 to load balancing servers on an ADC 1104. This solution can be applied to the load balancing servers 1108 of most types. In such way, more intelligent and enhanced way of security checks are being offered by application firewall.

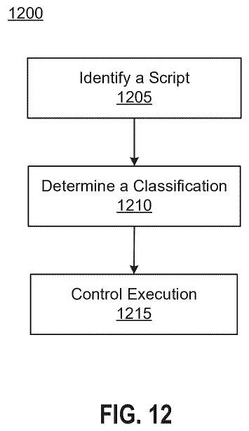

FIG. 12 is an example flow diagram of a method for identifying abnormal scripts by coding styles. The functionalities of the method may be implemented using, or performed by, any one or more of the components detailed herein in connection with FIGS. 1-11. In brief overview, a data processing system 240 may identify a script (operation 1205). The data processing system 240 may determine a classification (operation 1210). The data processing system 240 may control execution (operation 1215). In some embodiments, one or more operations of the process 1200 is performed by the data processing system 240. In some embodiments, one or more operations of the process 1200 is performed by one or more other entities. In some embodiments, the process 1200 includes more, fewer, or different steps than shown in FIG. 12.

Still referring to FIG. 12 in further detail, at operation 1205, one or more processors coupled to memory (e.g., data processing system 240, server 220, or computing device 230) can identify a script for execution by a computing device of an entity. The one or more processor may intercept a script transmitted from a server to a computing device. The one or more processor may identify a source of the scripts. The source can be a third-party repository or a certain entity.

At operation 1210, the one or more processors can determine, via a model trained with machine learning based on a plurality of scripts established by a plurality of entities, a classification of the script prior to execution of the script by the computing device. The one or more processor may classify the script as an “internal” or an “external” via the trained model. The internal may indicate that the scripts is developed internal to an entity. The external may indicate that the scripts is developed external to the entity. The one or more processor may detect any “external” scripts using an unfamiliar coding style.

At operation 1215, the one or more processors can control execution of the script responsive to the classification of the script. For instance, if a script is classified as “internal,” the one or more processors may allow execution of the script on the computing device. In another case, if the script is classified as “external,” the one or more processors may prevent execution of the script on the computing device. The one or more processors may send an alert notification or an analytic result to an user interface of an application. A user may make a final decision (e.g., to delete or keep the script) after reviewing the script.

The following examples pertain to further embodiments, from which numerous permutations and configurations will be apparent.

Example 1 includes a system, comprising: one or more processors, coupled to memory, to: identify a script for execution by a computing device of an entity. The one or more processors can determine, via a model trained with machine learning based on a plurality of scripts established by a plurality of entities, a classification of the script prior to execution of the script by the computing device. The one or more processors can control execution of the script responsive to the classification of the script.

Example 2 includes the subject matter of Example 1, wherein the data processing system can be intermediary to the computing device and one or more servers. The one or more processors can be configured to intercept the script transmitted from the one or more servers to the computing device prior to receipt by the computing device of the script. The one or more processors can be configured to determine, via the model and prior to forwarding the script to the computing device, that the classification indicates the script is authorized for execution by the computing device. The one or more processors can be configured to forward the script to the computing device for execution responsive to the script being authorized for execution by the computing device.

Example 3 includes the subject matter of any of Examples 1 and 2, wherein the computing device may comprise the data processing system. The one or more processors can be configured to receive, via a network, the script from a remote device configured to remotely manage the computing device, the script compatible with a plurality of different platforms and configured with a command-line shell. The one or more processors can be configured to determine, responsive to receipt of the script from the remote device and prior to execution of the script on the computing device, the classification of the script. The one or more processors can be configured to control, responsive to the classification, execution of the script to prevent execution of the script or allow execution of the script on the computing device.

Example 4 includes the subject matter of any of Examples 1 through 3, wherein the data processing system is further configured to: prevent execution of the script by the computing device responsive to the classification comprising an indication that the script was developed by a second entity that is different from the entity, wherein the computing device is managed by the entity.

Example 5 includes the subject matter of any of Examples 1 through 4, wherein the data processing system is further configured to: determine, via the model, the classification of the script as one of developed internal to the entity or developed external to the entity.

Example 6 includes the subject matter of any of Examples 1 through 5, wherein the data processing system is further configured to: scan the script to identify a plurality of values for a plurality of features of the script; and input the plurality of values for the plurality of features into the model to determine the classification.

Example 7 includes the subject matter of any of Examples 1 through 6, wherein the model is trained with a plurality of features of the plurality of scripts developed by the plurality of entities, the plurality of features comprising one or more features indicative of a coding style, a file attribute, or a code quality.

Example 8 includes the subject matter of any of Examples 1 through 7, wherein the data processing system is further configured to: determine, for the entity, a plurality of features established in the model for the entity, the plurality of features comprising at least one of a naming convention, bracket position, maximum line length, trailing whitespace, spare around keywords, style of cmdlet, or indentation; and scan the script to identify a plurality of values for the plurality of features established for the entity.

Example 9 includes the subject matter of any of Examples 1 through 8, wherein: a first value for a first feature of the plurality of features corresponding to the naming convention indicates an amount of words in the script that use a camel-case or a snake-case; and a second value for a second feature of the plurality of features corresponding to the bracket position indicates that a bracket is located at an end of a line in the script or the bracket is located at a head of the line in the script.

Example 10 includes the subject matter of any of Examples 1 through 9, wherein the data processing system is further configured to: receive a second plurality of scripts from a third-party repository; train an initial model based on a plurality of features of the second plurality of scripts, the plurality of features comprising one or more features indicative of a coding style, a file attribute, or a code quality; receive a third plurality of scripts developed by the entity; classify, via the initial model, the third plurality of scripts of the entity into a category in the initial model trained based on the second plurality of scripts from the third-party repository; and train, based on the initial model and the category, the model as a binary classifier to output the classification as one of internal or external.

Example 11 includes the subject matter of any of Examples 1 through 10, wherein the machine learning comprises at least one of a support vector machine, a linear kernel function, or a radial basis kernel function.

Example 12 includes a method, comprising: identifying, by a data processing system comprising one or more processors coupled with memory, a script for execution by a computing device of an entity; determining, by the data processing system via a model trained with machine learning based on a plurality of scripts established by a plurality of entities, a classification of the script prior to execution of the script by the computing device; and controlling, by the data processing system, execution of the script responsive to the classification of the script.

Example 13 includes the subject matter of Example 12, wherein the data processing system is intermediary to the computing device and one or more servers, comprising: intercepting, by the data processing system, the script transmitted from the one or more servers to the computing device prior to receipt by the computing device of the script; determining, by the data processing system via the model and prior to forwarding the script to the computing device, that the classification indicates the script is authorized for execution by the computing device; and forwarding, by the data processing system, the script to the computing device for execution responsive to the script being authorized for execution by the computing device.

Example 14 includes the subject matter of any of Examples 12 and 13, wherein the computing device comprises the data processing system, comprising: receiving, by the data processing system via a network, the script from a remote device configured to remotely manage the computing device, the script compatible with a plurality of different platforms and configured with a command-line shell; determining, by the data processing system responsive to receipt of the script from the remote device and prior to execution of the script on the computing device, the classification of the script; and controlling, by the data processing system responsive to the classification, execution of the script to prevent execution of the script or allow execution of the script on the computing device.

Example 15 includes the subject matter of any of Examples 12 through 14, comprising: preventing, by the data processing system, execution of the script by the computing device responsive to the classification comprising an indication that the script was developed by a second entity that is different from the entity, wherein the computing device is managed by the entity.

Example 16 includes the subject matter of any of Examples 12 through 15, comprising: determining, by the data processing system via the model, the classification of the script as one of developed internal to the entity or developed external to the entity.

Example 17 includes the subject matter of any of Examples 12 through 16, comprising scanning, by the data processing system, the script to identify a plurality of values for a plurality of features of the script; and inputting, by the data processing system, the plurality of values for the plurality of features into the model to determine the classification.

Example 18 includes the subject matter of any of Examples 12 through 17, comprising receiving, by the data processing system, a second plurality of scripts from a third-party repository; training, by the data processing system via the machine learning, an initial model based on a plurality of features of the second plurality of scripts, the plurality of features comprising one or more features indicative of a coding style, a file attribute, or a code quality, wherein the machine learning comprises at least one of a support vector machine, a linear kernel function, or a radial basis kernel function; receiving, by the data processing system, a third plurality of scripts developed by the entity; classifying, by the data processing system via the initial model, the third plurality of scripts of the entity into a category in the initial model trained based on the second plurality of scripts from the third-party repository; and training, by the data processing system, based on the initial model and the category, the model as a binary classifier to output the classification as one of internal or external.

Example 19 includes a non-transitory computer-readable medium storing instructions that, when executed by one or more processors, cause the one or more processors to: identify a script for execution by a computing device of an entity; determine, via a model trained with machine learning based on a plurality of scripts established by a plurality of entities, a classification of the script prior to execution of the script by the computing device; and control execution of the script responsive to the classification of the script.

Example 20 includes the subject matter of Example 19, wherein the model comprises a plurality of features comprising at least one of a naming convention, bracket position, maximum line length, trailing whitespace, spare around keywords, style of cmdlet, or indentation.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A system, comprising:
a data processing system comprising one or more processors, coupled with memory, to:
identify a script for execution by a computing device of an entity;
determine, via a model trained with machine learning based on a plurality of scripts established by a plurality of entities, a classification of the script prior to execution of the script by the computing device; and
control execution of the script responsive to the classification of the script.

2. The system of claim 1, wherein the data processing system is intermediary to the computing device and one or more servers, and is further configured to:
intercept the script transmitted from the one or more servers to the computing device prior to receipt by the computing device of the script;
determine, via the model and prior to forwarding the script to the computing device, that the classification indicates the script is authorized for execution by the computing device; and
forward the script to the computing device for execution responsive to the script being authorized for execution by the computing device.

3. The system of claim 1, wherein the computing device comprises the data processing system, and the data processing system is further configured to:
receive, via a network, the script from a remote device configured to remotely manage the computing device, the script compatible with a plurality of different platforms and configured with a command-line shell;
determine, responsive to receipt of the script from the remote device and prior to execution of the script on the computing device, the classification of the script; and
control, responsive to the classification, execution of the script to prevent execution of the script or allow execution of the script on the computing device.

4. The system of claim 1, wherein the data processing system is further configured to:
prevent execution of the script by the computing device responsive to the classification comprising an indication that the script was developed by a second entity that is different from the entity, wherein the computing device is managed by the entity.

5. The system of claim 1, wherein the data processing system is further configured to:
determine, via the model, the classification of the script as one of developed internal to the entity or developed external to the entity.

6. The system of claim 1, wherein the data processing system is further configured to:
scan the script to identify a plurality of values for a plurality of features of the script; and
input the plurality of values for the plurality of features into the model to determine the classification.

7. The system of claim 1, wherein the model is trained with a plurality of features of the plurality of scripts developed by the plurality of entities, the plurality of features comprising one or more features indicative of a coding style, a file attribute, or a code quality.

8. The system of claim 1, wherein the data processing system is further configured to:
determine, for the entity, a plurality of features established in the model for the entity, the plurality of features comprising at least one of a naming convention, bracket position, maximum line length, trailing whitespace, spare around keywords, style of cmdlet, or indentation; and
scan the script to identify a plurality of values for the plurality of features established for the entity.

9. The system of claim 8, wherein:
a first value for a first feature of the plurality of features corresponding to the naming convention indicates an amount of words in the script that use a camel-case or a snake-case; and
a second value for a second feature of the plurality of features corresponding to the bracket position indicates that a bracket is located at an end of a line in the script or the bracket is located at a head of the line in the script.

10. The system of claim 1, wherein the data processing system is further configured to:
receive a second plurality of scripts from a third-party repository;
train an initial model based on a plurality of features of the second plurality of scripts, the plurality of features comprising one or more features indicative of a coding style, a file attribute, or a code quality;
receive a third plurality of scripts developed by the entity;
classify, via the initial model, the third plurality of scripts of the entity into a category in the initial model trained based on the second plurality of scripts from the third-party repository; and
train, based on the initial model and the category, the model as a binary classifier to output the classification as one of internal or external.

11. The system of claim 10, wherein the machine learning comprises at least one of a support vector machine, a linear kernel function, or a radial basis kernel function.

12. A method, comprising:
identifying, by a data processing system comprising one or more processors coupled with memory, a script for execution by a computing device of an entity;
determining, by the data processing system via a model trained with machine learning based on a plurality of scripts established by a plurality of entities, a classification of the script prior to execution of the script by the computing device; and
controlling, by the data processing system, execution of the script responsive to the classification of the script.

13. The method of claim 12, wherein the data processing system is intermediary to the computing device and one or more servers, comprising:
intercepting, by the data processing system, the script transmitted from the one or more servers to the computing device prior to receipt by the computing device of the script;
determining, by the data processing system via the model and prior to forwarding the script to the computing device, that the classification indicates the script is authorized for execution by the computing device; and
forwarding, by the data processing system, the script to the computing device for execution responsive to the script being authorized for execution by the computing device.

14. The method of claim 12, wherein the computing device comprises the data processing system, comprising:
receiving, by the data processing system via a network, the script from a remote device configured to remotely manage the computing device, the script compatible with a plurality of different platforms and configured with a command-line shell;
determining, by the data processing system responsive to receipt of the script from the remote device and prior to execution of the script on the computing device, the classification of the script; and
controlling, by the data processing system responsive to the classification, execution of the script to prevent execution of the script or allow execution of the script on the computing device.

15. The method of claim 12, comprising:
preventing, by the data processing system, execution of the script by the computing device responsive to the classification comprising an indication that the script was developed by a second entity that is different from the entity, wherein the computing device is managed by the entity.

16. The method of claim 12, comprising:
determining, by the data processing system via the model, the classification of the script as one of developed internal to the entity or developed external to the entity.

17. The method of claim 12, comprising:
scanning, by the data processing system, the script to identify a plurality of values for a plurality of features of the script; and
inputting, by the data processing system, the plurality of values for the plurality of features into the model to determine the classification.

18. The method of claim 12, comprising:
receiving, by the data processing system, a second plurality of scripts from a third-party repository;
training, by the data processing system via the machine learning, an initial model based on a plurality of features of the second plurality of scripts, the plurality of features comprising one or more features indicative of a coding style, a file attribute, or a code quality, wherein the machine learning comprises at least one of a support vector machine, a linear kernel function, or a radial basis kernel function;
receiving, by the data processing system, a third plurality of scripts developed by the entity;
classifying, by the data processing system via the initial model, the third plurality of scripts of the entity into a category in the initial model trained based on the second plurality of scripts from the third-party repository; and
training, by the data processing system, based on the initial model and the category, the model as a binary classifier to output the classification as one of internal or external.

19. A non-transitory computer-readable medium comprising computer-executable instructions that, when executed by one or more processors, cause the one or more processors to:
identify a script for execution by a computing device of an entity;
determine, via a model trained with machine learning based on a plurality of scripts established by a plurality of entities, a classification of the script prior to execution of the script by the computing device; and
control execution of the script responsive to the classification of the script.

20. The non-transitory computer-readable medium of claim 19, wherein the model comprises a plurality of features comprising at least one of a naming convention, bracket position, maximum line length, trailing whitespace, spare around keywords, style of cmdlet, or indentation.
